(19) United States
(12) Patent Application Publication
(10) Pub. No.: US 2007/0075286 A1
(43) Pub. Date: Apr. 5, 2007

(54) Piezoelectric valves drive

(75) Inventor: Edward T. Tanner, Williamsburg, VA (US)

Correspondence Address: NIXON & VANDERHYE, PC, 901 NORTH GLEBE ROAD, 11TH FLOOR, ARLINGTON, VA, 22203, US

(73) Assignee: PAR Technologies, LLC, Hampton, VA (US)

(21) Appl. No.: 11/242,137

(22) Filed: Oct. 4, 2005

(51) Int. Cl. F16K 31/02

(52) U.S. Cl. 251/129.06

(57) ABSTRACT

A valve (20) comprises a valve body (22) having for defining a valve chamber (28) and having plural ports (P). A flow restrictor (32) is situated in the valve chamber (28) for providing selective communication of fluid between selected ones of the plural ports (P). One or more piezoelectric actuator(s) (40) displace the flow restrictor (32) to achieve the communication of the fluid between selected ones of the plural ports (P). In one example embodiment a biasing element (48) is situated in the valve chamber opposite the piezoelectric actuator (40). In another example embodiment, two piezoelectric actuators (40) are provided, one at each of opposing ends of the valve chamber (28).

### BACKGROUND

1. Field of the Invention

The present invention pertains to valves, and particularly to valves such as servo or spool valves.

2. Related Art and other Considerations

Servovalves are used in many applications. Most servovalves are typically driven by an electromagnetic “torque motor”, such as the servovalve whose operation is illustrated in FIG. 11A and FIG. 11B. In having, e.g., an electromagnetic torque motor, these servovalves are inherently slow to respond to their input signal. This response time places an upper limit on the frequency with which they can operate. According to a major manufacturer of servovalves (Moog, Inc.): “better frequency response represents a technical frontier to today's servovalve, and probably the greatest technological challenge. The need for higher response will be palpably felt in environments in which servos must interface at the power end with electronics. Examples occur in radar drives, laser pointers, and in the material test field.”

Another problem foisted upon a servovalve by the typical electromagnetic drive system is overshoot. Because of the electromagnetic drive, the spool comprising a servovalve tends to overshoot its desired position. This also translates into an undesirable overshoot in the device that is being controlled by the sevovalve.

### BRIEF SUMMARY

A valve comprises a valve body for defining a valve chamber and having plural ports. A flow restrictor is situated in the valve chamber for providing selective communication of fluid between the plural ports. A piezoelectric actuator serves for displacing the flow restrictor to achieve the selective communication of the fluid between the plural ports. In some embodiments, the piezoelectric actuator is also situated also in the valve chamber.

In some non-limiting implementations or applications, the flow restrictor takes the form of a valve spool is situated in the valve chamber. In such implementations or applications, the valve body has two opposing end walls and at least one sidewall extending between the opposing end walls. The valve body defines a valve chamber between the opposing end walls and within the sidewall. The valve chamber has a major axis extending between the opposing end walls. The valve body has plural ports provided on the sidewall. The valve spool is arranged for linear displacement along the major axis and for controlling communication of fluid between selected ones of the plural ports in accordance with the displacement. The piezoelectric actuator is situated in the valve chamber between one of the end walls of the valve body and an axial end of the valve spool.

In a first example, non-limiting embodiment, a biasing element is situated in the valve chamber between a second one of the end walls of the valve body and a second end of the flow restrictor, e.g., the valve spool. The biasing element can take the form of a spring.

In another example, non-limiting embodiment, two piezoelectric actuators are provided in the valve chamber, one at each end of the valve chamber. In other words, a first piezoelectric actuator is situated in the valve chamber between a first of the end walls of the valve body and a first end of the flow restriction (e.g., valve spool) and a second piezoelectric actuator is situated in the valve chamber between a second of the end walls of the valve body and a second end of the flow restrictor. The first piezoelectric actuator is electrically connected out of phase or poled oppositely to the second piezoelectric actuator.

For embodiments having piezoelectric actuators situated on opposing sides of the flow restrictor, the flow restrictor can be accurately positioned in its neutral position (e.g., in absence of applied voltage) by slightly compressing the piezoelectric element(s) of each of the two opposing piezoelectric actuators.

The piezoelectric actuators of either embodiment can comprise a stack of plural piezoelectric elements. In embodiments having a first piezoelectric actuator comprising a first stack of piezoelectric elements and a second piezoelectric actuator having a second stack of piezoelectric elements, preferably the first stack of plural piezoelectric elements and the second stack of plural piezoelectric elements have a same number of piezoelectric elements.

In one example implementation, the piezoelectric actuator comprises two piezoelectric elements at least partially joined or at least partially contacting (e.g., at their peripheries) to form a piezoelectric bellows or clamshell-shaped section. For embodiments having two piezoelectric actuators at respective first and second ends of the valve chamber, both the first piezoelectric actuator and the second piezoelectric actuator comprise plural piezoelectric bellows sections, each piezoelectric bellows section comprising two piezoelectric elements at least partially joined or at least partially contacting. In such embodiment, preferably the first piezoelectric actuator and the second piezoelectric actuator have a same number of piezoelectric bellows sections.

As an optional feature, the valve chamber can have an adjustable effective volume. As another optional feature, a measurement system can be provided which uses a signal applied to the piezoelectric actuator and a measured signal obtained from the piezoelectric actuator to determine an indication of position of the flow restrictor.

In an example implementation, the valve is a servo valve and the flow restrictor is a linearly displaceable spool. The piezoelectric actuators can be used for valves of other configurations and applications, such as (for example) proportional valves, including other embodiments which do not utilize a valve spool as the flow restrictor.

### BRIEF DESCRIPTION OF THE DRAWINGS

The foregoing and other objects, features, and advantages of the invention will be apparent from the following more particular description of preferred embodiments as illustrated in the accompanying drawings in which reference characters refer to the same parts throughout the various views. The drawings are not necessarily to scale, emphasis instead being placed upon illustrating the principles of the invention.

FIG. 1A is a sectioned side view of a valve according to a first example, non-limiting embodiment, showing the valve in a first or neutral position; FIG. 1B is a sectioned side view showing the valve of FIG. 1A in a second or left position; and FIG. 1C is a sectioned side view showing the valve of FIG. 1A in a third or right position.

FIG. 2A is a sectioned side view of a valve according to a second example, non-limiting embodiment, showing the valve in a first or neutral position; FIG. 2B is a sectioned side view showing the valve of FIG. 2A in a second or left position; and, FIG. 2C is a sectioned side view showing the valve of FIG. 2A in a third or right position.

FIG. 3A is a sectioned side view of a valve according to an implementation of the second embodiment wherein two piezoelectric actuators comprise a stack of plural piezoelectric elements, showing the valve in a first or neutral position; FIG. 3B is a sectioned side view showing the valve of FIG. 3A in a second or left position; and, FIG. 3C is a sectioned side view showing the valve of FIG. 3A in a third or right position.

FIG. 4A is a sectioned side view of a bellows section comprised of two piezoelectric elements which have their respective edges or peripheries at least partially bonded together; FIG. 4B is a front view of the bellows section of FIG. 4A.

FIG. 5 is a sectioned side view of a bellows section comprised of two piezoelectric elements which have their respective edges or peripheries oriented toward one another but not bonded together.

FIG. 6A is a sectioned side view of a valve according to another implementation of the second embodiment wherein two piezoelectric actuators comprise a stack of plural piezoelectric sections, each piezoelectric section comprising two piezoelectric elements which have their respective edges or peripheries oriented to form a bellows section; FIG. 6A showing the valve in a first or neutral position; FIG. 6B is a sectioned side view showing the valve of FIG. 6A in a second or left position; and, FIG. 6C is a sectioned side view showing the valve of FIG. 6A in a third or right position.

FIG. 7A is a diagrammatic side view of a stack of bellows sections to which a negative drive signal is applied; FIG. 7B is a diagrammatic side view showing a positive drive signal applied to the stack of FIG. 7A.

FIG. 8 is a sectioned side view of a valve according to another embodiment which has adjustable stop assemblies.

FIG. 9 is a diagrammatic side view of an example, non-limiting embodiment of a proportional valve.

FIG. 10 is a sectioned side view of a valve according to another example, non-limiting embodiment, the valve being used in conjunction with a measuring system.

FIG. 11A and FIG. 11B are diagrammatic views of fluid flow in different states of a conventional servovalve.

### DETAILED DESCRIPTION OF THE DRAWINGS

In the following description, for purposes of explanation and not limitation, specific details are set forth such as particular architectures, interfaces, techniques, etc. in order to provide a thorough understanding of the present invention. However, it will be apparent to those skilled in the art that the present invention may be practiced in other embodiments that depart from these specific details. That is, those skilled in the art will be able to devise various arrangements which, although not explicitly described or shown herein, embody the principles of the invention and are included within its spirit and scope. In some instances, detailed descriptions of well-known devices, circuits, and methods are omitted so as not to obscure the description of the present invention with unnecessary detail. All statements herein reciting principles, aspects, and embodiments of the invention, as well as specific examples thereof, are intended to encompass both structural and functional equivalents thereof. Additionally, it is intended that such equivalents include both currently known equivalents as well as equivalents developed in the future, i.e., any elements developed that perform the same function, regardless of structure.

Thus, for example, it will be appreciated by those skilled in the art that block diagrams herein can represent conceptual views of illustrative circuitry embodying the principles of the technology. Such circuitry may include dedicated hardware as well as hardware capable of executing software in association with appropriate software, or “processors” or “controllers” which may include, without limitation, digital signal processor (DSP) hardware, read only memory (ROM) for storing software, random access memory (RAM), and non-volatile storage.

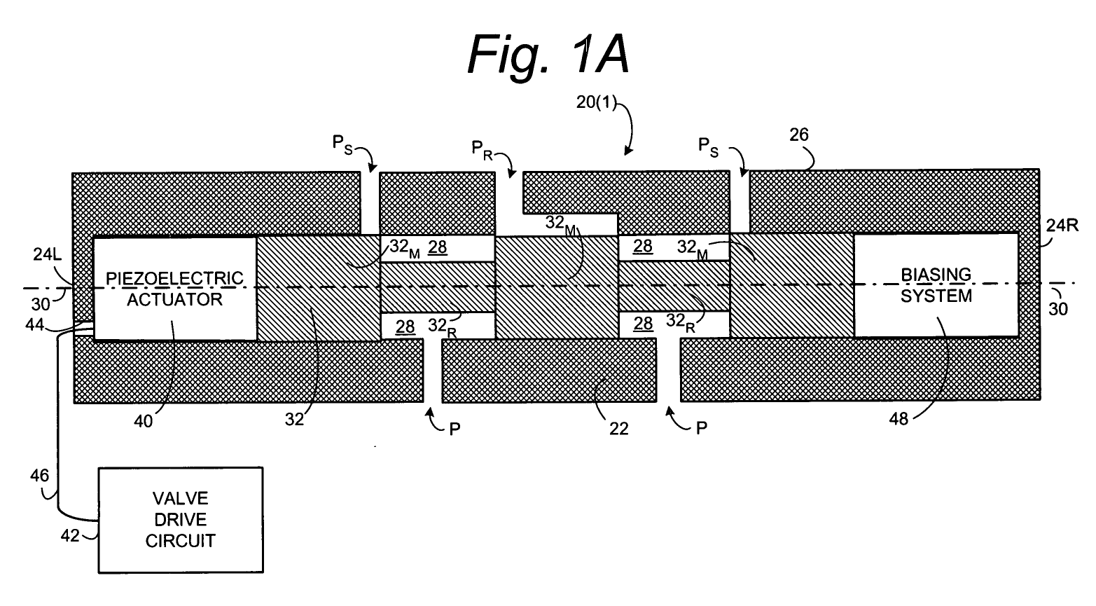

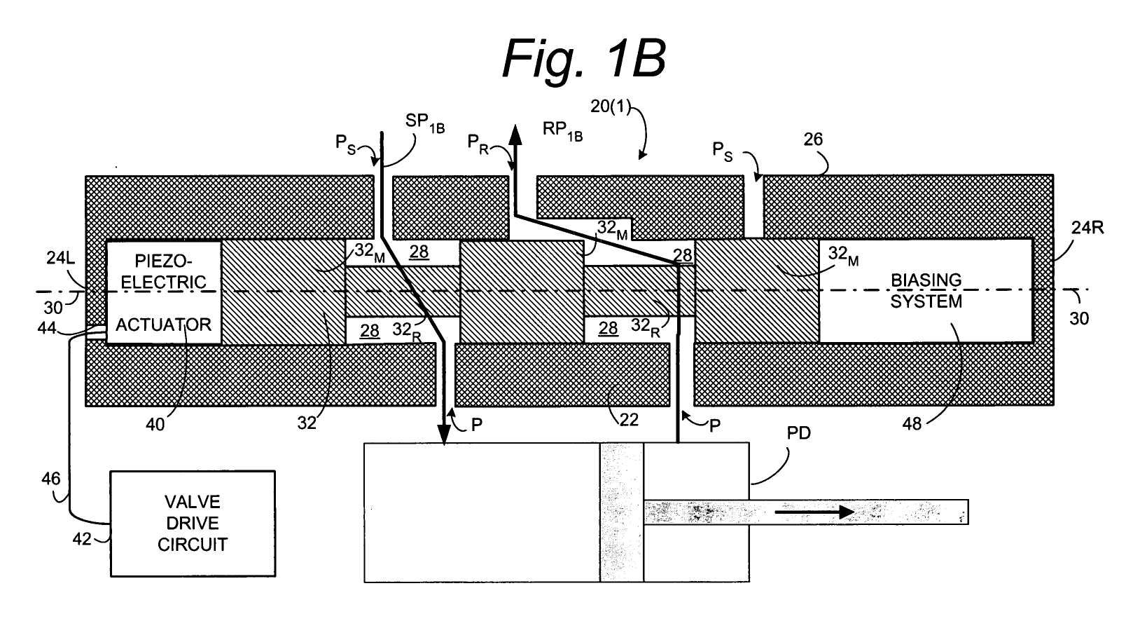

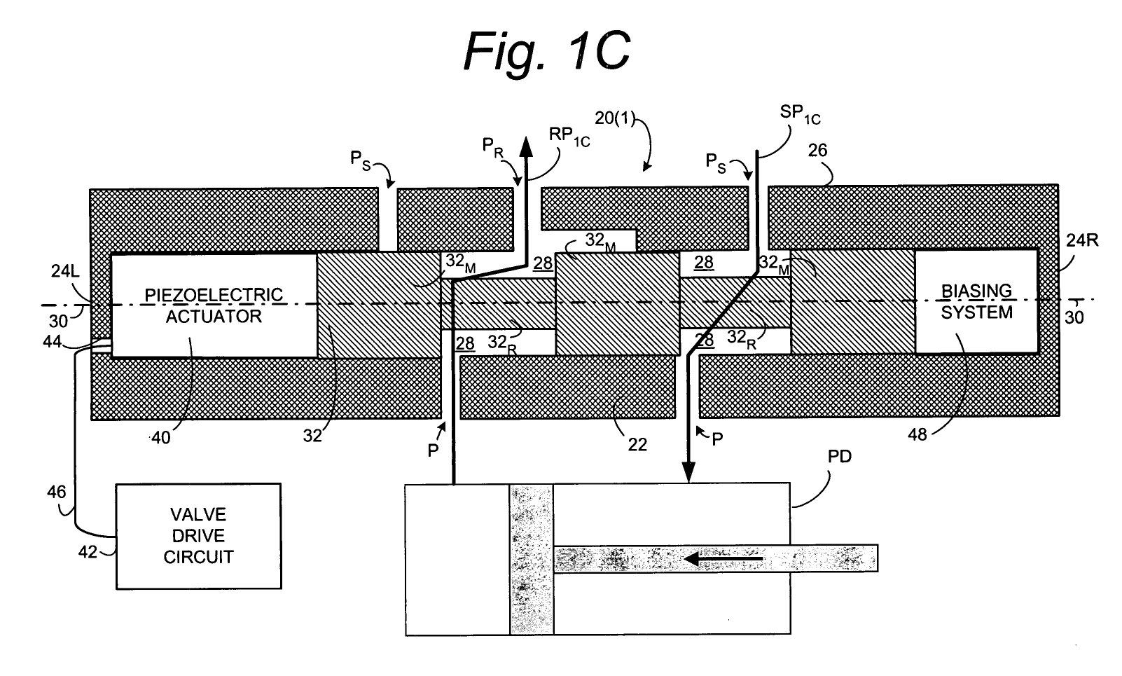

FIG. 1A shows a first example, non-limiting embodiment of a valve 20(1) which comprises a valve body 22 having two opposing end walls 24L, 24R and at least one sidewall 26 extending between the opposing end walls 24L, 24R. The valve body 22 defines a valve chamber 28 between the opposing end walls 24L, 24R and within the sidewall 26. The valve chamber 28 has a major axis 30 extending between the opposing end walls 24L, 24R. The valve body 22 has plural ports P provided at various locations on the sidewall 26, including fluid supply ports P_{S} and fluid return port P_{R}.

A flow restrictor is situated in valve chamber 28. The flow restrictor can be an element such as a valve spool 32 which slides back and forth in a fixed-sized chamber, e.g., valve chamber 28. Thus, in an illustrated, non-limiting example embodiment, the flow restrictor takes the form of valve spool 32 arranged for linear displacement along the major axis 30. In the illustrated embodiment, preferably valve chamber 28 is cylindrical in shape and sized to accommodate valve spool 32, which is also (preferably but not necessarily) cylindrical and essentially solid.

The valve spool 32 is configured for controlling communication of fluid between selected ones of the plural ports P in accordance with the displacement. For example, along its major axis the valve spool 32 is configured with three maximum diameter spool sections 32_{M} and two reduced diameter spool sections 32_{R}. Two of the maximum diameter spool sections 32_{M} are extremity spool sections, one of the extremity maximum diameter spool sections 32_{M} being at a left end of valve spool 32 and another of the extremity maximum diameter spool sections 32_{M} being at a right end of valve spool 32. Adjacent the left extremity maximum diameter spool section 32_{M} is a first of the reduced diameter spool sections 32_{R}; adjacent the right extremity maximum diameter spool section 32_{M} is a second of the reduced diameter spool sections 32_{R}. A third or intermediate maximum diameter spool section 32_{M} is situated between the two reduced diameter spool sections 32_{R}. In view of the fact that valve spool 32 occupies a substantial amount of an intermediate portion of valve chamber 28, reference numerals for valve chamber 28 are situated primarily in empty spaces proximate the reduced diameter spool sections 32_{R} in FIG. 1A.

As with other embodiments herein described, the flow restrictor (e.g., valve spool 32) can occupy essentially an infinite number of positions within valve chamber 28. However, three primary positions are herein illustrated: a first or neutral position; a second or left position; and a third or right position. FIG. 1A particularly shows the flow restrictor in the first or neutral position. In the first or neutral position, no fluid communication occurs between ports P_{S} and any other port; and no fluid communication occurs between port P_{R} and any other port.

The valve 20(1) further includes a piezoelectric actuation system. The piezoelectric actuation system comprises a piezoelectric actuator 40 and a valve drive circuit 42. In the embodiment of FIG. 1A, piezoelectric actuator 40 is situated in the valve chamber 28 between one of the end walls of the valve body 22 and an end of the valve spool. In the example embodiment of FIG. 1A, piezoelectric actuator 40 is situated in valve chamber 28 between end wall 24L and a left end of valve spool 32. An opening or aperture 44 is provided in housing end wall 24L so that one or more electrical leads 46 can extend therethrough for connection to valve drive circuit 42. The valve drive circuit 42 can be provided or situated remotely from valve body 22. Alternatively, valve drive circuit 42 can be embedded in or carried on valve body 22.

In the example embodiment of FIG. 1A, a biasing element 48 is situated in valve chamber 28 between a second one of the end walls of the valve body (e.g., end wall 24R) and a second (e.g., right) end of valve spool 32. The biasing element 48 can take the form of a spring, for example, or other elastic member with which can exert a spring-type force on valve spool 32. The biasing element 48 serves essentially to center valve spool 32 (in the absence of applied power) to the piezoelectric actuator 40 and to provide a restoring force which acts to return valve spool 32 to its neutral (center) position as shown in FIG. 1A.

While FIG. 1A shows valve spool 32 in its first or center position, FIG. 1B shows valve spool 32 in its second or left position. To acquire the second or left position shown in FIG. 1B, the valve drive circuit 42 applies power, e.g., a proper voltage, to piezoelectric actuator 40 so that piezoelectric actuator 40 contracts, compresses, or otherwise retracts in the portion of chamber 28 which it previously occupied. For example, a positive voltage applied by drive circuit 42 can cause such contraction. At essentially the same time, the biasing force exerted by biasing element 48, sensing the void left by the contracting piezoelectric actuator 40, expands in chamber 28 and thereby drives valve spool 32 toward the left. As a result of the leftward displacement of valve spool 32 to the second or left position shown in FIG. 1B, fluid is able to flow or communicate from supply port P_{S} to a first of the ports P along a supply path SP_{1B}, and fluid is able to flow or communicate from a second of the ports P to the return port P_{R} along a return path RP_{1B}.

FIG. 1B further shows how the fluid communication facilitated by the second or left position of valve spool 32 can be utilized for operating a piston type device PD. In its second or left position, valve spool 32 facilitates fluid flow in a manner to extend a piston of piston device PD. Of course, piston device PD is just one example type of device with which valve 20 can be utilized. Piston device PD or comparable devices are not shown in drawings for other embodiments described herein, although it certainly should be understood that the other embodiments can be comparably connected and utilized.

FIG. 1C shows valve spool 32 in its third or right position. To acquire the third or right position shown in FIG. 1C, the valve drive circuit 42 applies power, e.g., a proper voltage, to piezoelectric actuator 40 so that piezoelectric actuator 40 expands, flexes, or otherwise extends in the portion of chamber 28 which it previously occupied. For example, a negative voltage applied by drive circuit 42 can cause such expansion. At essentially the same time, biasing element 48, sensing the force caused by expansion of piezoelectric actuator 40, contracts or compresses in chamber 28, so that valve spool 32 travels toward the right. As a result of the rightward displacement of valve spool 32 to the third or right position shown in FIG. 1C, fluid is able to flow or communicate from supply port P_{S} to a second of the ports P along a supply path SP_{1C}, and fluid is able to flow or communicate from the first of the ports P to the return port P_{R} along a return path RP_{1C}.

FIG. 1C also shows how the fluid communication facilitated by the third or right position of valve spool 32 can be utilized for operating the piston type device PD. In its third or right position, valve spool 32 facilitates fluid flow in a manner to retract a piston of piston device PD.

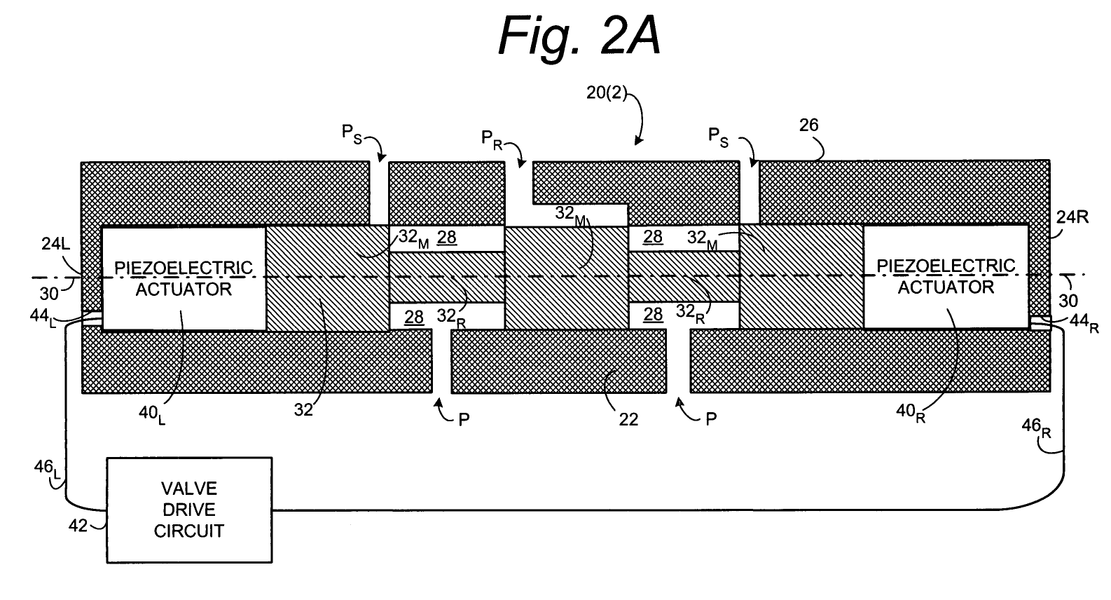

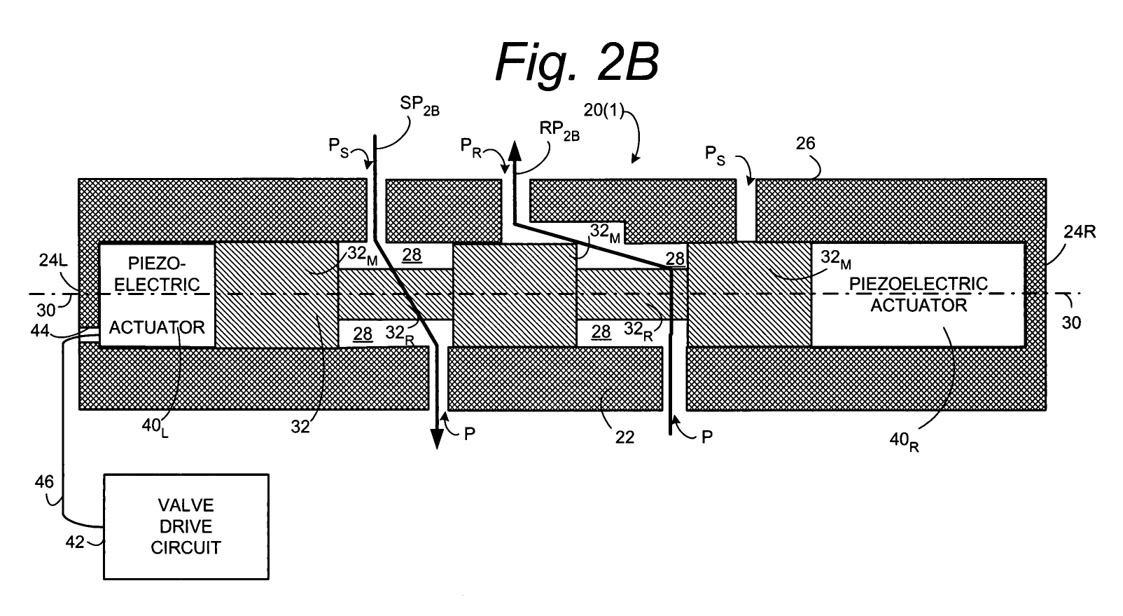

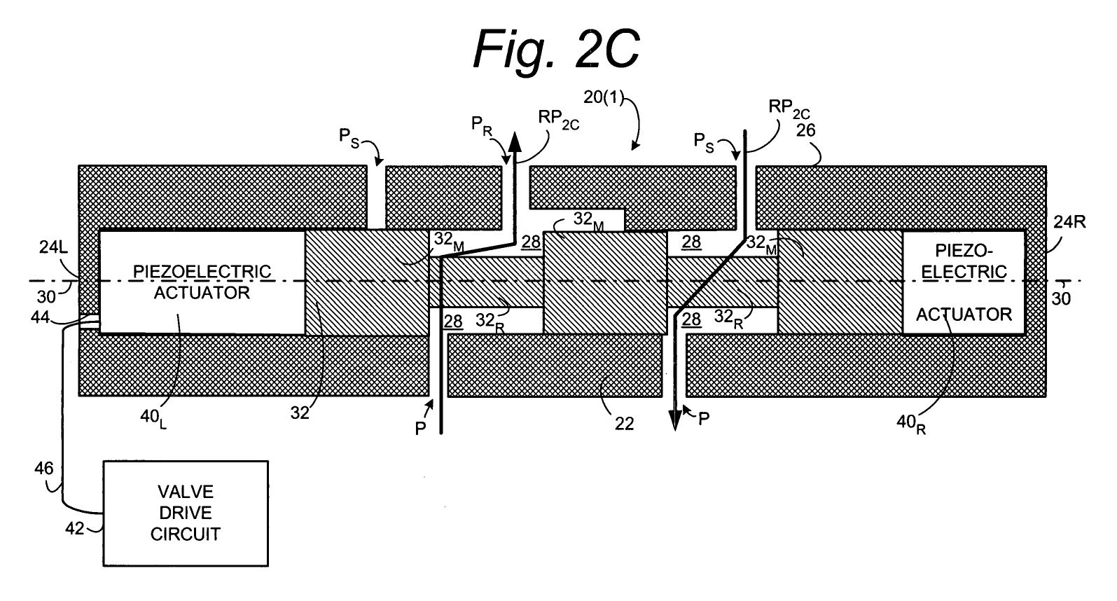

In another example, non-limiting embodiment illustrated in FIG. 2A, valve 20(2) comprises a piezoelectric actuation system having two piezoelectric actuators 40_{L} and 40_{R} provided in valve chamber 28, with one piezoelectric actuator being provided at each end of valve chamber 28. In particular, a first piezoelectric actuator 40_{L} is situated in valve chamber 28 between a first of the end walls 24L of valve body 22 and a first end of valve spool 32. In addition, a second piezoelectric actuator 40_{R} is situated in valve chamber 28 between a second of the end walls end walls 24R of valve body 22 and a second end of valve spool 32. Both piezoelectric actuators 40_{L} and 40_{R} are connected to valve drive circuit 42.

Just as FIG. 1B of the first embodiment shows valve spool 32 in its second or left position, so FIG. 2B of the second embodiment shows its valve spool 32 in its second or left position. To acquire the second or left position shown in FIG. 2B, the valve drive circuit 42 applies power, e.g., a proper voltage, to piezoelectric actuator 40_{L} so that piezoelectric actuator 40_{L} contracts, compresses, or otherwise retracts in the portion of chamber 28 which it previously occupied. For example, a positive voltage applied by drive circuit 42 can cause such contraction. At essentially the same time, valve drive circuit 42 applies power to piezoelectric actuator 40_{R}. If piezoelectric actuator 40_{R} is poled in the same direction as piezoelectric actuator 40_{L}, the polarity of the drive signal applied by drive circuit 42 to piezoelectric actuator 40_{R} is opposite to the polarity of the drive signal applied by drive circuit 42 to piezoelectric actuator 40_{L}, i.e., the drive signal applied by drive circuit 42 to piezoelectric actuator 40_{R} is negative. Alternatively, if piezoelectric actuator 40_{R} is poled in an opposite direction to the poling of piezoelectric actuator 40_{L}, the polarity of the drive signal applied by drive circuit 42 to piezoelectric actuator 40_{R} has the same polarity as does the drive signal applied by drive circuit 42 to piezoelectric actuator 40_{L}, i.e., the drive signal applied by drive circuit 42 to piezoelectric actuator 40_{R} is positive. In either case, the drive signal applied to piezoelectric actuator 40_{R} causes the piezoelectric actuator 40_{R} to expand, flex, or otherwise extend in the portion of chamber 28 which it previously occupied, thereby driving valve spool 32 toward the left. As a result of the leftward displacement of valve spool 32 to the second or left position shown in FIG. 2B, fluid is able to flow or communicate from supply port P_{S} to a first of the ports P along a supply path SP_{2B}, and fluid is able to flow or communicate from a second of the ports P to the return port PR along a return path RP_{2B}.

Similarly, FIG. 2C shows valve spool 32 in its third or right position. To acquire the third or right position shown in FIG. 2C, the valve drive circuit 42 applies power, e.g., a proper voltage, to piezoelectric actuator 40_{L} so that piezoelectric actuator 40_{L} expands, flexes, or otherwise extends in the portion of chamber 28 which it previously occupied. For example, a negative voltage applied by drive circuit 42 can cause such expansion. At essentially the same time, valve drive circuit 42 applies power to piezoelectric actuator 40_{R}. If piezoelectric actuator 40_{R} is poled in the same direction as piezoelectric actuator 40_{L}, the polarity of the drive signal applied by drive circuit 42 to piezoelectric actuator 40_{R} is opposite to the polarity of the drive signal applied by drive circuit 42 to piezoelectric actuator 40_{L}, i.e., the drive signal applied by drive circuit 42 to piezoelectric actuator 40_{R} is positive. Alternatively, if piezoelectric actuator 40_{R} is poled in an opposite direction to the poling of piezoelectric actuator 40_{L}, the polarity of the drive signal applied by drive circuit 42 to piezoelectric actuator 40_{R} has the same polarity as does the drive signal applied by drive circuit 42 to piezoelectric actuator 40_{L}, i.e., the drive signal applied by drive circuit 42 to piezoelectric actuator 40_{R} is negative. In either case, the drive signal applied to piezoelectric actuator 40_{R} causes the piezoelectric actuator 40_{R} to compress or retract, whereby valve spool 32 travels toward the right. As a result of the rightward displacement of valve spool 32 to the third or right position shown in FIG. 2C, fluid is able to flow or communicate from supply port P_{S} to a second of the ports P along a supply path SP_{2C}, and fluid is able to flow or communicate from the first of the ports P to the return port P_{R} along a return path RP_{2C}.

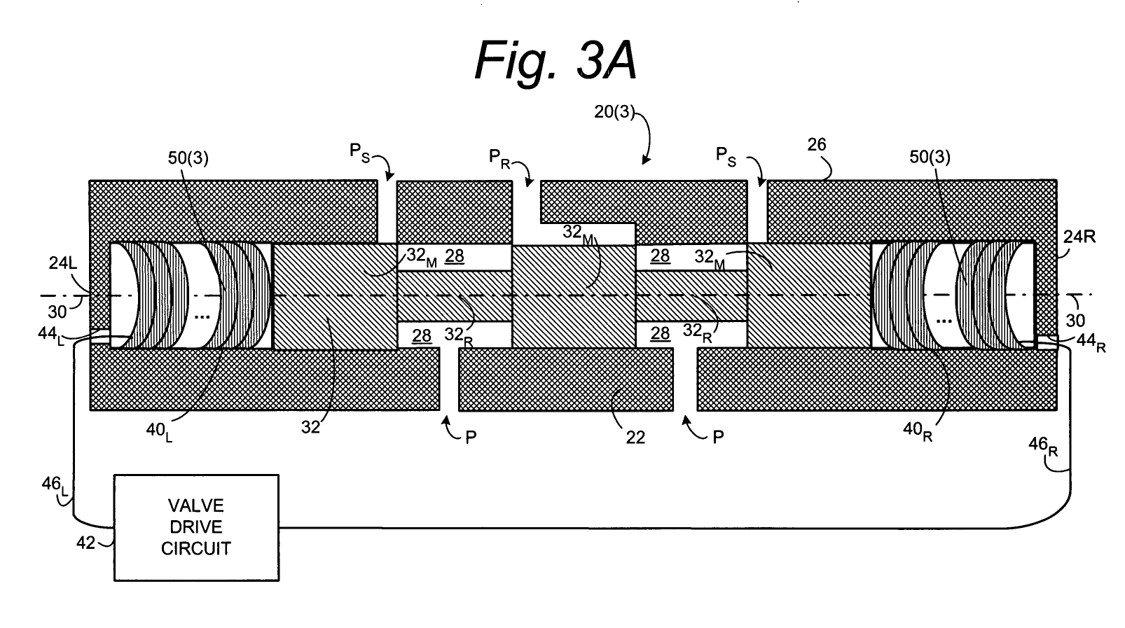

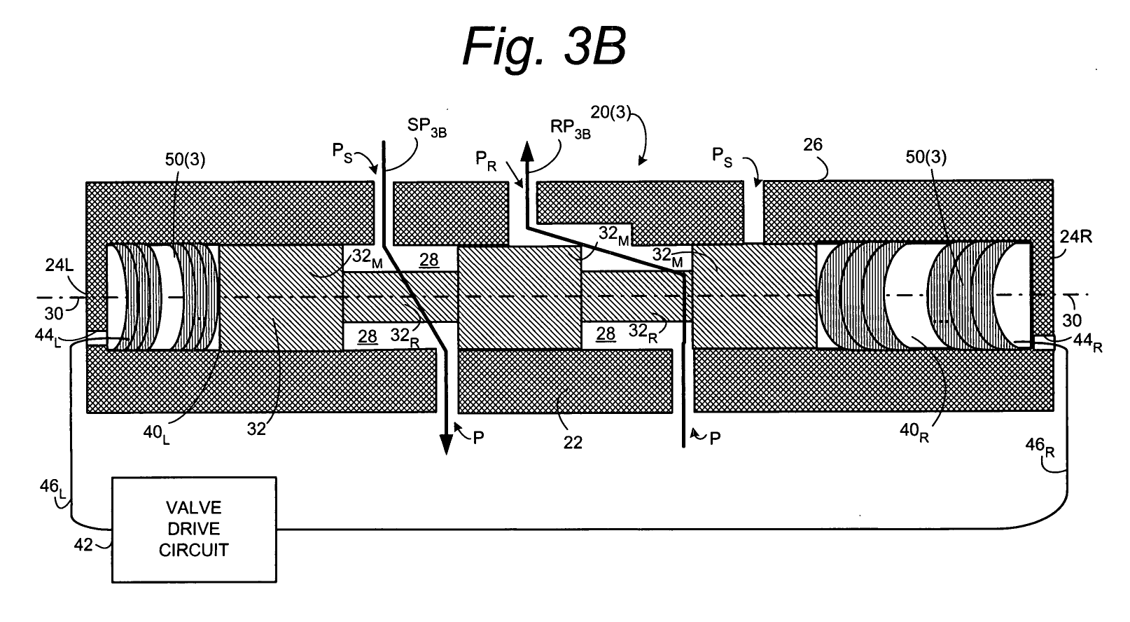

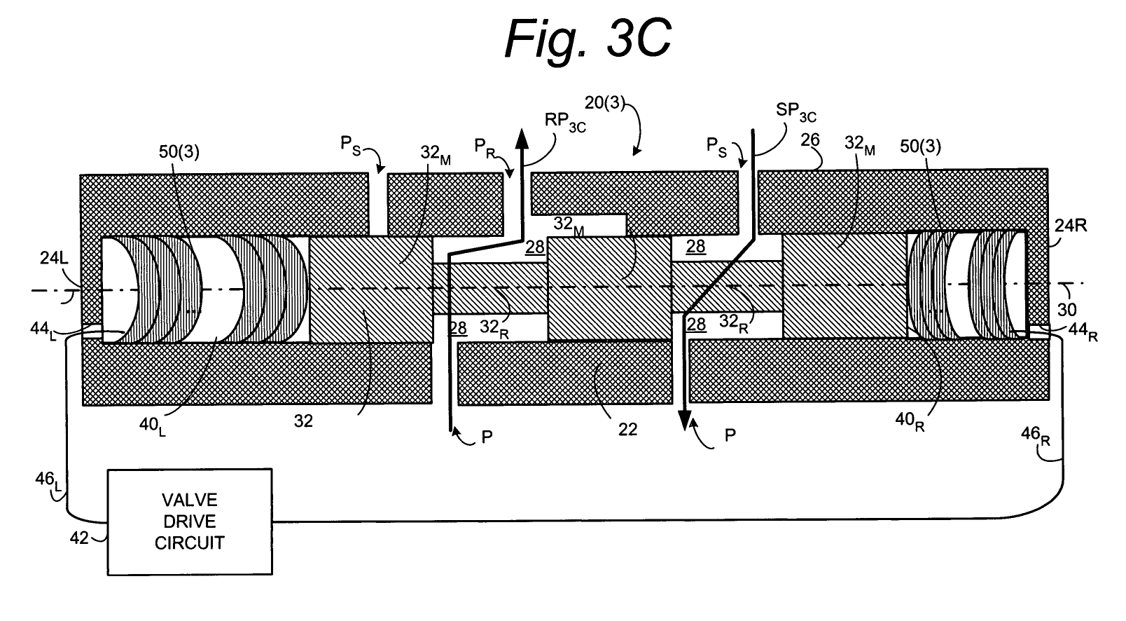

The piezoelectric actuator 40 of the embodiment of FIG. 1A (having one piezoelectric actuator 40) and the piezoelectric actuators 40_{L} and 40_{R} of the embodiment of FIG. 2A can comprise a stack of plural piezoelectric elements. For example, FIG. 3A illustrates an implementation of the embodiment of FIG. 2A wherein both piezoelectric actuators 40_{L} and 40_{R} comprise a stack of plural piezoelectric elements 50(3). Such a stack can be realized by a series arrangement of piezoelectric elements arranged (preferably in direct or at least indirect contacting relation) along major axis 30.

In one example implementation, the piezoelectric elements 50(3) can take the form of a multi-layered laminate (also known as a ruggedized laminated piezoelectric member). The multi-layered laminate can comprise a piezoelectric wafer which is laminated by an adhesive between a metallic substrate layer and an outer metal layer. Electrical leads for activating the piezoelectric wafer can be connected to electrodes which may be sputtered or otherwise formed on opposite sides of the piezoelectric wafer, or connected to the metallic substrate layer and outer metal layer. Example structures of the multi-layered piezoelectric laminate and processes for fabricating the same are described in or discernable from one or more of the following (all of which are incorporated herein by reference in their entirety): PCT Patent Application PCT/US01/28947, filed 14 Sep. 2001; U.S. patent application Ser. No. 10/380,547, filed Mar. 17, 2003, entitled “Piezoelectric Actuator and Pump Using Same”; U.S. patent application Ser. No. 10/380,589, filed Mar. 17, 2003; and U.S. Provisional Patent Application 60/670,692, filed Apr. 13, 2005, entitled “Piezoelectric Diaphragm Assembly with Conductors On Flexible Film”, all of which are incorporated herein by reference.

For embodiments having two piezoelectric actuators, i.e., one at each end of valve spool 32, the piezoelectric actuator positioned at one end of the valve spool 32 is electrically connected out of phase (or poled oppositely) to the piezoelectric actuator positioned at the other end of the valve spool 32. For example, for as many piezoelectric elements 50(3) as may be provided in piezoelectric actuator 40_{L}, all such piezoelectric elements 50(3) are electrically connected the same, but out of phase to all the piezoelectric elements (one or more) which may be provided in piezoelectric actuator 40_{R}.

Each piezoelectric element 50(3) is connected to the electrical leads 46 feeding its respective piezoelectric actuator 40 (although such connections are not necessarily shown for all piezoelectric elements). In accordance with the electrical signals applied on the electrical leads 46, each piezoelectric element 50(3) can have any one of several configurations. For example, in accordance with the magnitude and polarity of the applied electrical signal, each piezoelectric element 50(3) can have an essentially planar configuration, a slightly flexed (e.g., domed or curved) configuration, or significantly flexed configuration. The differing degrees of flexure of the piezoelectric elements 50 comprising the stack are used to govern positioning of valve spool 32 within valve chamber 28, and thereby communication or not of fluid through ports P of valve body 22.

In embodiments having a first piezoelectric actuator comprising a first stack of piezoelectric elements and a second piezoelectric actuator having a second stack of piezoelectric elements, preferably the first stack of plural piezoelectric elements and the second stack of plural piezoelectric elements have a same number of piezoelectric elements. For example, in the illustrated implementation of FIG. 3A, if piezoelectric actuator 40_{L} has eight piezoelectric elements 50(3), then piezoelectric actuator 40_{R} would also have eight piezoelectric elements 50(3). It will be appreciated that a greater or lesser (even one) number of piezoelectric elements 50(3) may be provided for each piezoelectric actuator. As a general rule, the number of piezoelectric elements in each stack is related to the required displacement of valve spool 32 and the force necessary to move valve spool 32. The size of valve chamber 28, and hence the space available at the ends of the valve chamber 28, can be adjusted (e.g., designed to have a capacity) to suit or accommodate the required number of piezoelectric elements for the particular application.

In similar manner as with like suffixed earlier drawings, FIG. 3A shows valve spool 32 of valve 20(3) in its first or center position, FIG. 3B shows valve spool 32 in its second or left position, and FIG. 3C shows valve spool 32 in its third or right position

To acquire the second or left position shown in FIG. 3B, the valve drive circuit 42 applies power, e.g., a proper voltage, to the piezoelectric elements 50(3) comprising piezoelectric actuator 40_{L} so that the piezoelectric elements 50(3) comprising piezoelectric actuator 40_{L} flatten or compress (or otherwise retract). At essentially the same time, valve drive circuit 42 applies power to the piezoelectric elements 50(3) comprising piezoelectric actuator 40_{R}. If the piezoelectric elements 50(3) comprising piezoelectric actuator 40_{R} are poled in the same direction as the piezoelectric elements 50(3) comprising piezoelectric actuator 40_{L}, the polarity of the drive signal applied by drive circuit 42 to the piezoelectric elements 50(3) comprising piezoelectric actuator 40_{R} is opposite to the polarity of the drive signal applied by drive circuit 42 to piezoelectric actuator 40_{L}. Alternatively, if the piezoelectric elements 50(3) comprising piezoelectric actuator 40_{R} are poled in an opposite direction to the poling of the piezoelectric elements 50(3) comprising piezoelectric actuator 40_{L}, the polarity of the drive signal applied by drive circuit 42 to the piezoelectric elements 50(3) comprising piezoelectric actuator 40_{R} has the same polarity as does the drive signal applied by drive circuit 42 to the piezoelectric elements 50(3) comprising piezoelectric actuator 40_{L}. In either case, the drive signal applied to the piezoelectric elements 50(3) comprising piezoelectric actuator 40_{R} causes the piezoelectric elements 50(3) comprising the piezoelectric actuator 40_{R} to expand, flex, or otherwise extend, thereby driving valve spool 32 toward the left. As a result of the leftward displacement of valve spool 32 to the second or left position shown in FIG. 3B, fluid is able to flow or communicate from supply port P_{S} to a first of the ports P along a supply path SP_{3B}, and fluid is able to flow or communicate from a second of the ports P to the return port P_{R} along a return path RP_{3B}.

Similarly, FIG. 3C shows valve spool 32 of valve 20(3) in its third or right position. To acquire the third or right position shown in FIG. 3C, the valve drive circuit 42 applies power to the piezoelectric elements 50(3) comprising piezoelectric actuator 40_{L} so that the piezoelectric elements 50(3) comprising piezoelectric actuator 40_{L} expand, flex, or otherwise extend. At essentially the same time, valve drive circuit 42 applies power to the piezoelectric elements 50(3) comprising piezoelectric actuator 40_{R}. In view of either opposite poling of the the piezoelectric elements or opposite polarity of the drive signal, the drive signal applied to the piezoelectric elements 50(3) comprising piezoelectric actuator 40_{R} causes the piezoelectric elements 50(3) comprising the piezoelectric actuator 40_{R} to compress or retract, whereby valve spool 32 travels toward the right. As a result of the rightward displacement of valve spool 32 to the third or right position shown in FIG. 3C, fluid is able to flow or communicate from supply port P_{S} to a second of the ports P along a supply path SP_{3C}, and fluid is able to flow or communicate from the first of the ports P to the return port P_{R} along a return path RP_{3C}.

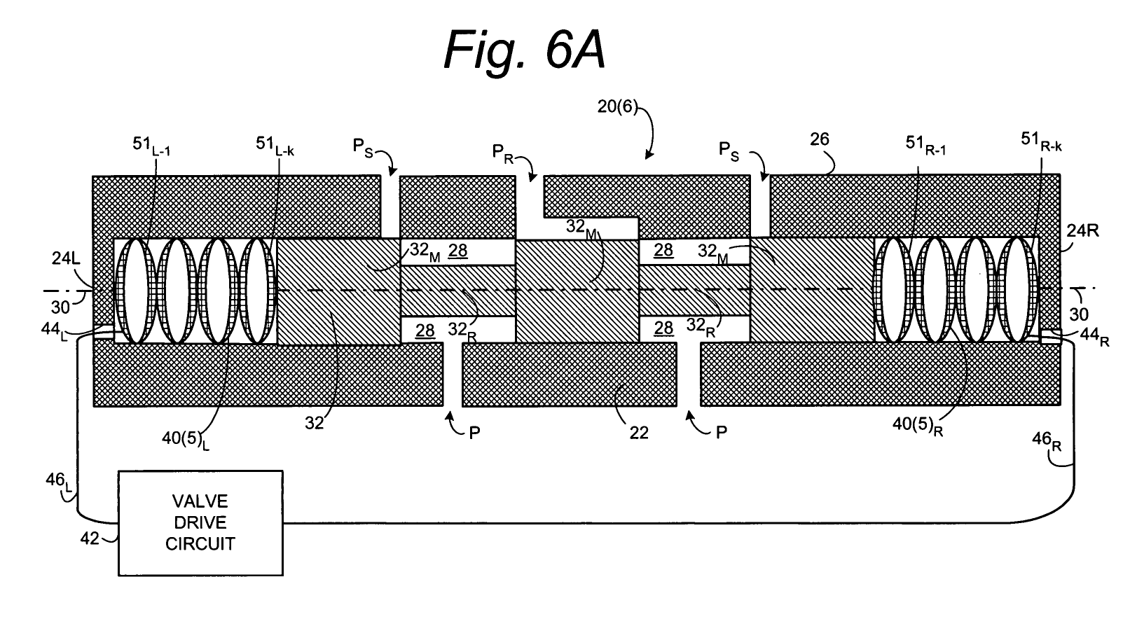

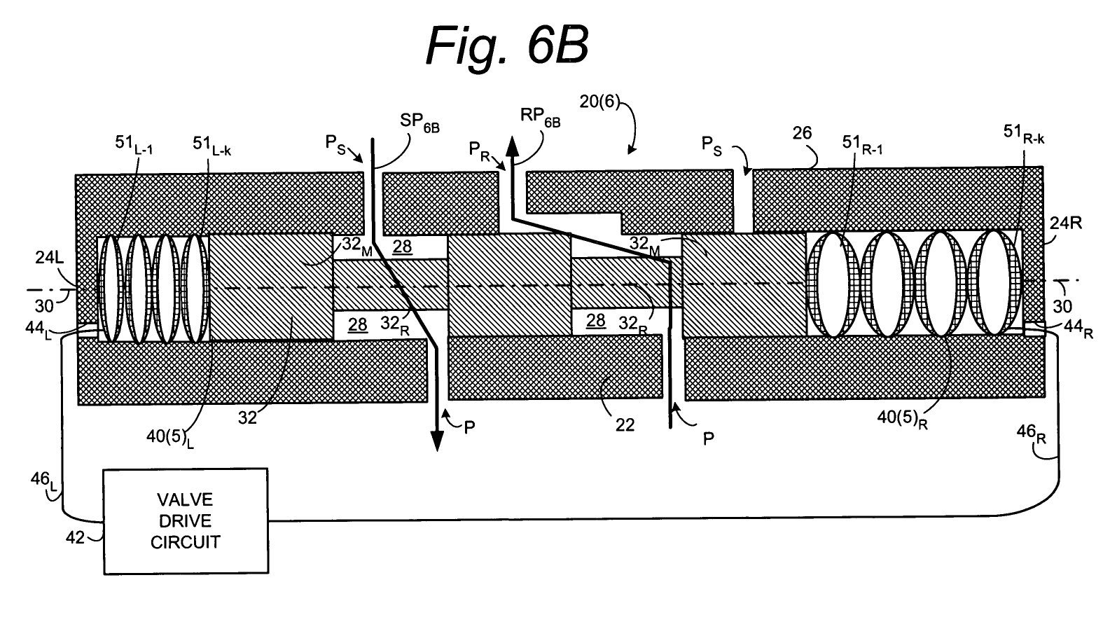

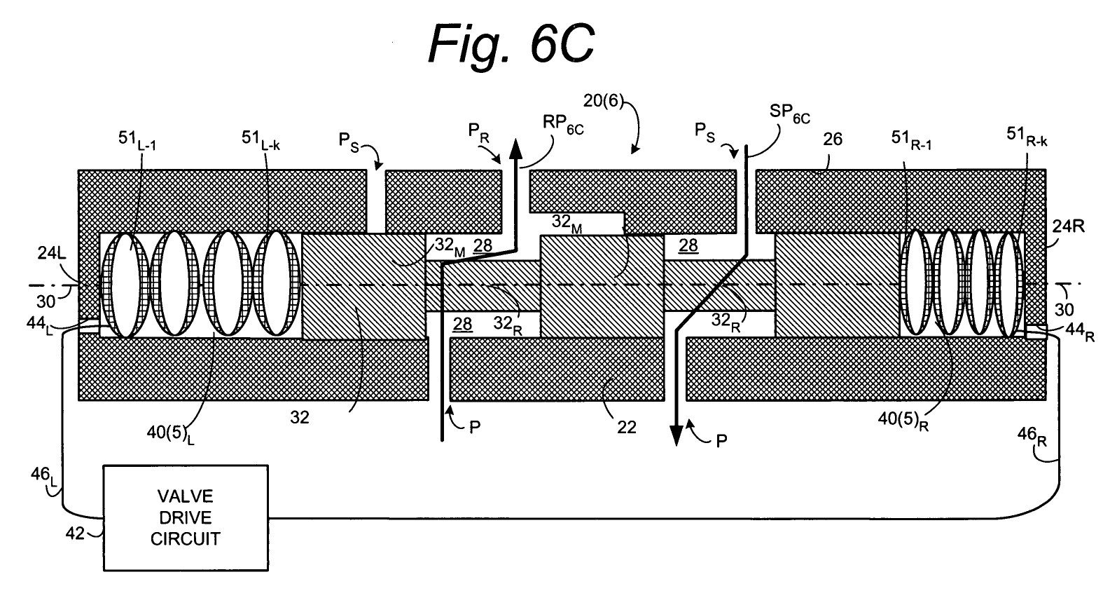

The example embodiment of FIG. 3A-FIG. 3C is particularly suited for valve applications in which a large force (but small displacement) is required to move valve spool 32. For applications in which larger spool displacements are required, other arrangements (such as those described below with reference to FIG. 6) may be more advantageous.

In another example implementation, the piezoelectric actuator comprises two piezoelectric elements oriented to form a piezoelectric bellows section. “Oriented to form a piezoelectric bellows section” includes a configuration in which two piezoelectric elements are at least partially joined (e.g., at their peripheries), another configuration in which two piezoelectric elements are at least partially contacting (e.g., at their peripheries), and other comparable configurations as well.

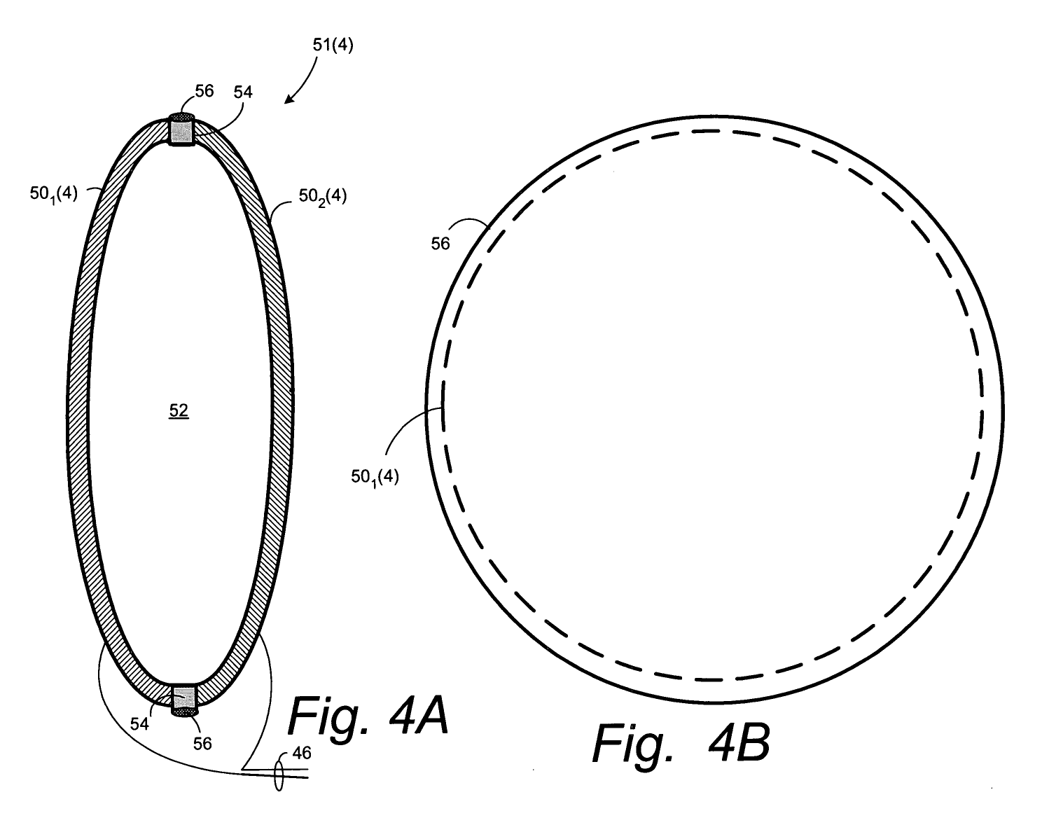

Thus, in one configuration of the bellows implementation, two piezoelectric elements of a bellows section can be at least partially joined at their peripheries. For example, FIG. 4A and FIG. 4B show, in cross section side view, two piezoelectric elements 50₁(4) and 50₂(4) which have their respective edges or peripheries at least partially bonded together to form a bellows section 51(4) having a bellows chamber 52 internally defined between piezoelectric elements 50₁(4) and 50₂(4). In an example implementation, each of the piezoelectric elements 50₁(4) and 50₂ (4) can take the form of a multi-layered laminate (also known as a ruggedized laminated piezoelectric member) such as those described above.

The bonding of piezoelectric elements 50₁(4) and 50₂(4) can be realized in various ways, as taught, for example, in U.S. patent application Ser. No. 11/024,943, filed Dec. 30, 2004 by Vogeley et al., entitled “PUMPS WITH DIAPHRAGMS BONDED AS BELLOWS”, which is incorporated herein by reference in its entirety, or by documents referenced and/or incorporated by reference therein. For example, a sealing gasket 54 may be inserted an between edge of piezoelectric element 50₁(4) and edge of piezoelectric element 50₂(4), and an epoxy 56 or other adhesive or sealant applied externally over the edges of the piezoelectric elements 50(4) and sealing gasket 54. The sealing gasket 54 and epoxy 56 may reside essentially completely around the edges of piezoelectric elements 50₁(4) and 50₂(4). In other implementations, in which the bellows chamber 52 need not be fluid tight, the peripheries of piezoelectric elements 50₁(4) and 50₂(4) can be bonded, either partially or entirely, in different ways.

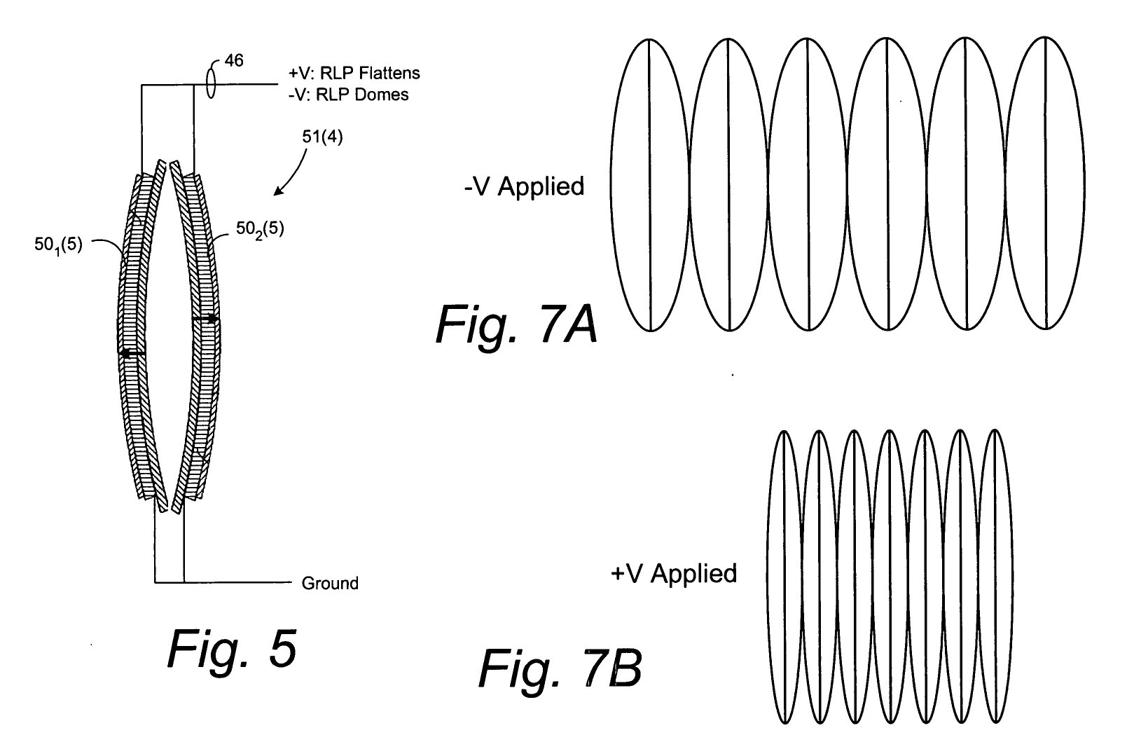

In another configuration of the bellows implementation, illustrated in FIG. 5, two piezoelectric elements 50₁(5) and 502(5) of a bellows section 51(5) can be nearly or at least partially contacting at their peripheries. As such, the two piezoelectric elements of a bellows section are bowed or arched away from one another in similar manner as the implementation of FIG. 4A, but do not have their peripheries (which may be contacting) bonded together.

FIG. 6A-FIG. 6C show an example, non-limiting embodiment of a valve 20(6) comprising a piezoelectric actuation system having two piezoelectric actuators 40(6)_{L} and 40(6)_{R}, with both first piezoelectric actuator 40(6)_{L} and the second piezoelectric actuator 40(6)_{R} comprising plural piezoelectric bellows sections 51. The piezoelectric actuator 40(6)_{L} includes bellows section 51_{L-1} (closest to end wall 24L) through 51_{L-k} (closest to valve spool 32), while piezoelectric actuator 40(6)_{R} includes bellows section 51_{R-1} (closest to valve spool 32) through 51_{R-k} (closest to end wall 24R). Preferably the first piezoelectric actuator 40(6)_{L} and the second piezoelectric actuator 40(6)_{R} have a same number of piezoelectric bellows sections 51. Although in the illustrated embodiment, both first piezoelectric actuator 40(6)_{L} and the second piezoelectric actuator 40(6)_{R} have k=4 piezoelectric bellows sections 51, it will be appreciated that a greater or lesser number (even one) bellows section 51 may be provided for each piezoelectric actuator.

Together, as in either the periphery bonded embodiment of FIG. 4A and FIG. 4B or the periphery contacting embodiment of FIG. 5, piezoelectric elements 50₁ and 50₂ form a bellows section 51 of the piezoelectric actuator 40. The piezoelectric actuators 40 (either one or both, depending on embodiment and implementation) may comprise one such bellows sections 51, or a stack of plural bellows sections 51. The bellows section 51 essentially has a clam shell or oyster shape or configuration.

As in previous embodiments, each piezoelectric element 50 of each bellows section 51 of FIG. 6A-FIG. 6C is connected to the electrical leads 46 feeding its respective piezoelectric actuator 40 (although such connections are not necessarily shown for all piezoelectric elements). In an example implementation, application of a negative drive signal to the piezoelectric elements 50 comprising each piezoelectric actuator 40 causes the piezoelectric elements 50 to flex or expand along axis 30 as shown in FIG. 7A, thereby lengthening each bellows section 51 along axis 30. Conversely, application of a positive drive signal to the piezoelectric elements 50 comprising each piezoelectric actuator 40 causes the piezoelectric elements 50 to contract along axis 30 to a more planar configuration as shown in FIG. 7B.

The example embodiment of FIG. 6A-FIG. 6C is particularly suited for applications in which large spool displacements are required. In the piezoelectric actuator configuration of an embodiment such as FIG. 6A-FIG. 6C, the displacement of each piezoelectric element 50 is essentially additive, thereby producing a larger overall displacement as a result of the facing orientation of two piezoelectric elements, and (in stacked embodiments) the stacking of plural bellows section 51.

In similar manner as with like suffixed earlier drawings, FIG. 6A shows valve spool 32 of valve 20(6) in its first or center position, FIG. 6B shows valve spool 32 in its second or left position, and FIG. 6C shows valve spool 32 in its third or right position As a result of the leftward displacement of valve spool 32 to the second or left position shown in FIG. 6B, fluid is able to flow or communicate from supply port P_{S} to a first of the ports P along a supply path SP_{6B}, and fluid is able to flow or communicate from a second of the ports P to the return port P_{R} along a return path RP_{6B}. As a result of the rightward displacement of valve spool 32 to the third or right position shown in FIG. 6C, fluid is able to flow or communicate from supply port P_{S} to a second of the ports P along a supply path SP_{6C}, and fluid is able to flow or communicate from the first of the ports P to the return port P_{R} along a return path RP_{6C}.

For embodiments having piezoelectric actuators situated on opposing sides of valve spool 32, the valve spool 32 can be accurately positioned in its neutral position (e.g., in absence of applied voltage) by slightly compressing the piezoelectric element(s) of each of the two opposing piezoelectric actuators. The valve spool 32 is essentially sandwiched between two piezoelectric actuators 40. The opposing two piezoelectric actuators 40 respectively comprise opposing piezoelectric elements or opposing stacks of piezoelectric elements, or opposing bellows sections or opposing stacks of bellows sections. By sizing the components so that the entire arrangement of piezoelectric actuator 40_{L}, valve spool 32, and piezoelectric actuator 40_{R} is slightly compressed in valve chamber 28, a spring-like nature of the compressed piezoelectric elements will provide an equal force (in opposing directions along major axis 30) to each side of valve spool 32. This opposing, equal force will essentially keep valve spool 32 centered in the absence of an applied voltage to the piezoelectric elements 50.

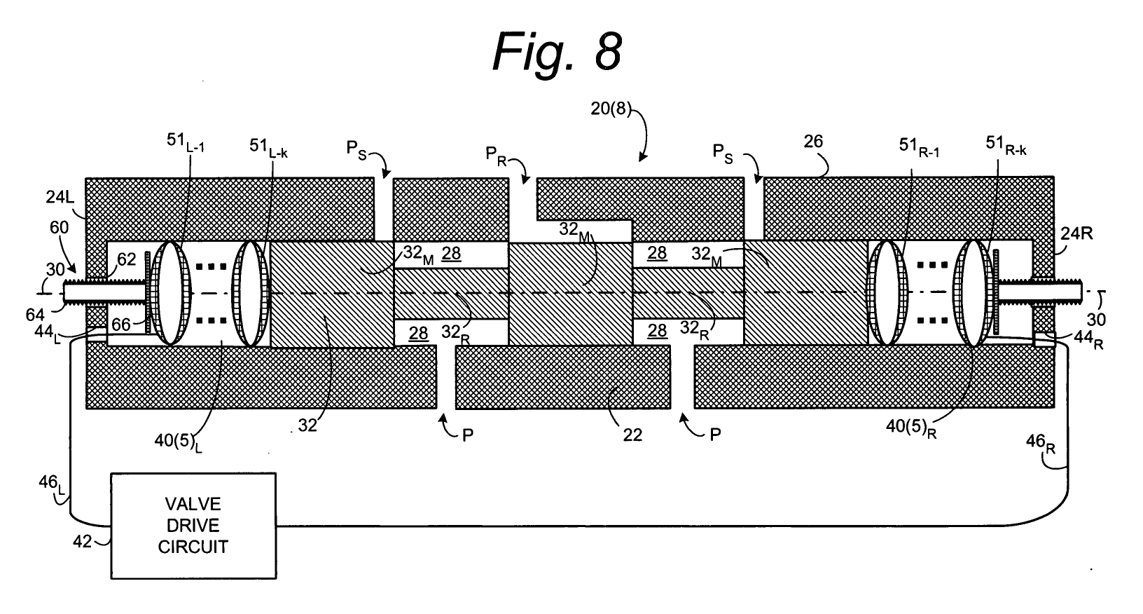

In the embodiments thus far illustrated, an extremity of each piezoelectric actuator 40 contacts or abuts an interior surface of an end wall 24 of valve body 22. For example, a leftmost piezoelectric element in piezoelectric actuator 40_{L} contacts end wall 24L, while a rightmost piezoelectric element in piezoelectric actuator 40_{R} contacts end wall 24R. Such not necessarily be the case in the previously illustrated or other embodiments. For example, rather than being confined by an end wall, extremities of piezoelectric actuators 40 can be confined by a stop or other termination member which extends interiorly into valve chamber 28. The effective stop or termination position of such stop or other termination member may be adjustable if desired. For example, FIG. 8 illustrates a valve 20(8) having adjustable stop assemblies 60 for the respective piezoelectric actuators 40. Each end wall 24L, 24R is provided with a threaded access aperture 62 through which a counter-threaded rod 64 extends. Each rod 64 carries at its distal end a stop member 66 which can take the form of a disk or the like which can revolve within valve chamber 28 with the rotation of threaded rod 64 as stop adjustment is achieved. By adjusting the position of stop member 66, the effective volume of valve chamber 28 (i.e., the volume usable by the piezoelectric actuators and valve spool after setting of the stops) can be adjustable. Therefore, the valve 20(8) of FIG. 8 has a valve chamber 28 of adjustable effective volume. It will be appreciated that FIG. 8 shows valve 20(8) with its spool in a first or neutral position, but that like other embodiments herein illustrated and described the spool of valve 20(8) can acquire a second or left position and a third or right position, among its other infinite positions along axis 30. The person skilled in the art will further appreciate that there are other ways of providing a valve chamber with an adjustable effective volume.

Provision of adjustable stops as described above can also facilitate centering of valve spool 32 in valve chamber 28 during assembly. In all embodiments described or contemplated herein, for fabrication one of the end walls 24L, 24R can (optionally) be removable for assembly, so that the piezoelectric actuator(s) 40 and valve spool 32 can be axially inserted therein followed by closure of the removable end wall.

In an example embodiments and implementations illustrated, the valve is a servo valve and the valve spool 32 is a linearly displaceable or translatable element. The piezoelectric actuators can be used for valves of other configurations and applications, such as (for example) proportional valves. A proportional valve can be conceptualized as a one-way valve with a variable flow restriction element, e.g., flow restrictor. The flow restrictor may, or may not be, a spool. The flow restrictor is actuated by a piezoelectric actuator (such as any of the embodiments described above or otherwise encompassed hereby) in a manner such that the deflection of the flow restrictor is proportional to some applied signal (voltage, current, etc.). Since the flow restriction is proportional to the applied signal, the resulting flow through the valve is proportional to the applied signal as well.

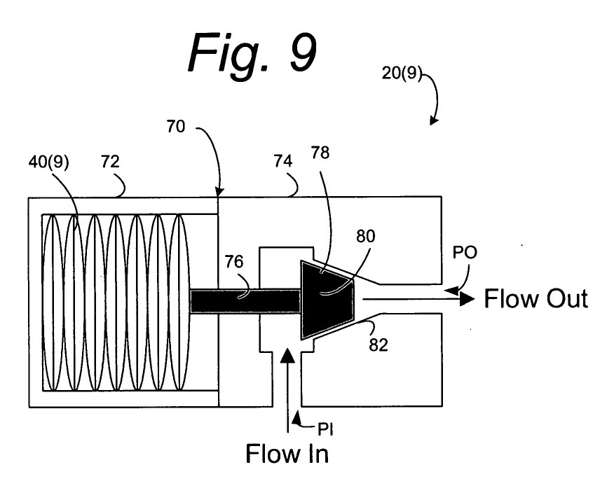

An example proportional valve 20(9) is illustrated in FIG. 9. Proportional valve 20(9) comprises valve body 70. Valve body has an actuator housing section 72 and a flow restrictor housing section 74. The actuator housing section 72 at least partially encloses a piezoelectric actuator 40(9) which, in the example implementation, comprises a stack of bellows sections as previously discussed. As understood from previous embodiments, piezoelectric actuator 40(9) is connected to unillustrated valve drive circuitry. It will be appreciated that other structures as herein described or encompassed are also suitable for the piezoelectric actuator of valve 20(9), including non-bellows types of piezoelectric actuators and piezoelectric actuators having a greater or lesser number of sections or piezoelectric elements. An extreme one of the piezoelectric elements comprising piezoelectric actuator 40(9) is attached or affixed to a stem 76 of flow restrictor 78. Flow restrictor 78 has a head 80 which, in the illustrated embodiment, takes the form of a truncated cone. Depending on the degree of actuation of piezoelectric actuator 40(9), the flow restrictor head 80 may bear against and thereby block a passage 82 internally formed in flow restrictor housing section 74, or may be spaced away from passage 82 in order to permit fluid flow between an input port PI and an output port PO formed in flow restrictor housing section 74.

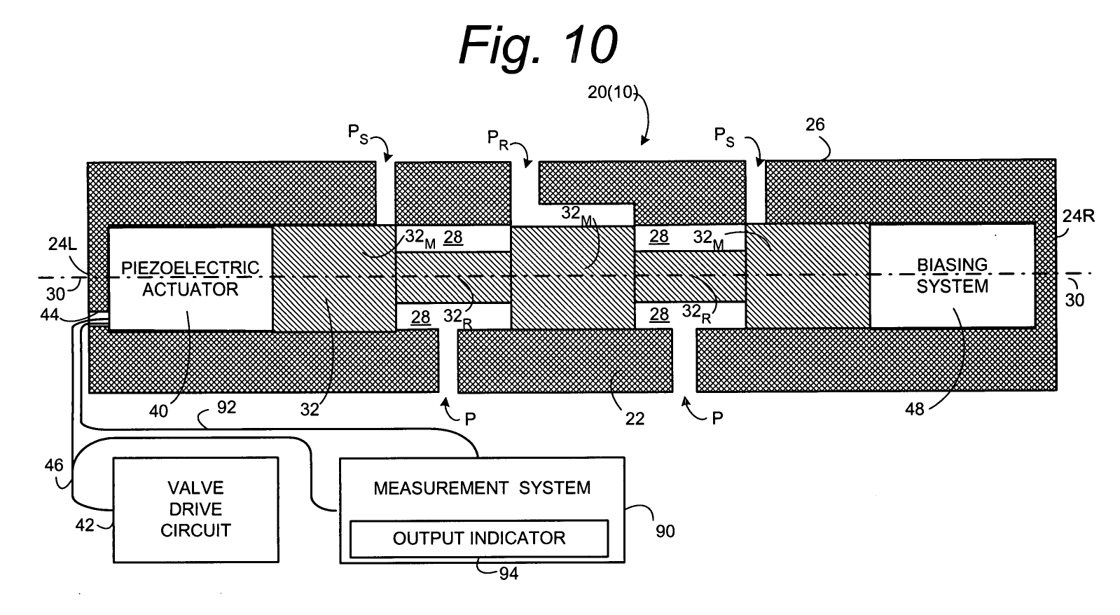

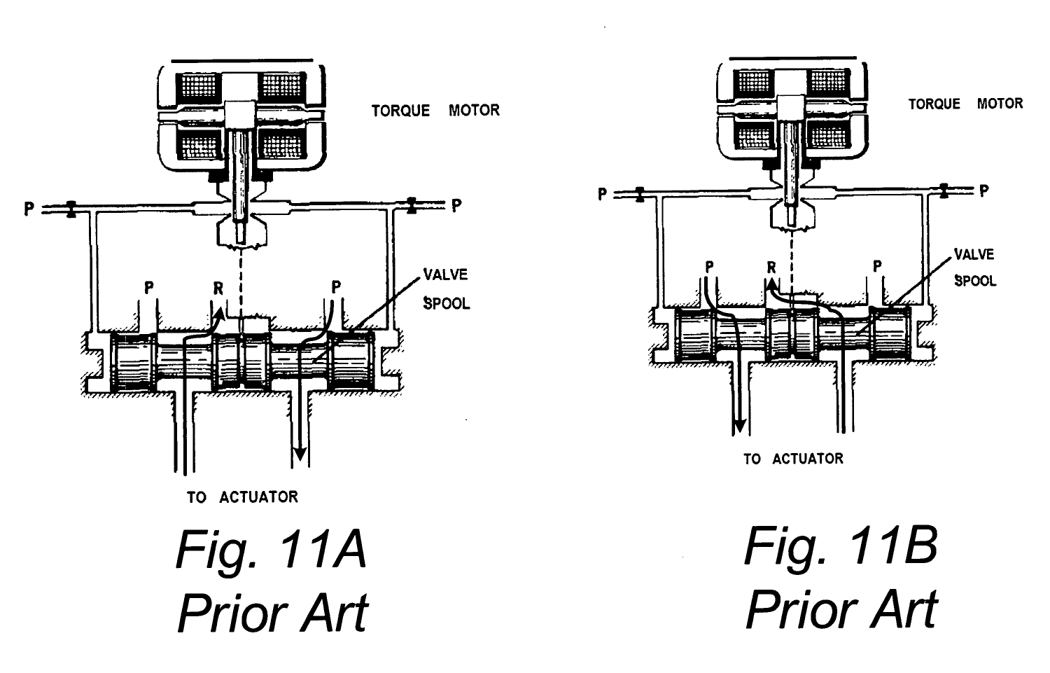

FIG. 10 resembles FIG. 1A in providing a generic illustration of a valve, and particularly illustrates a valve 20(10) having measurement system 90. The spool position indication system 90 comprises a circuit, processor, or controller which is connected to application lead(s) 46 and to measurement lead(s) 92. The application lead(s) 46 are the aforementioned leads which apply an electrical signal (voltage) to the one or more piezoelectric elements comprising the one or more piezoelectric actuators, thereby causing the piezoelectric elements to displace or deform (and therefore, strain) in accordance with the magnitude and polarity of the electrical signal. The measurement lead(s) 92 are connected to the respective piezoelectric elements comprising the piezoelectric actuator(s), and carry an electrical signal generated by the respective piezoelectric elements as a result of displacement of the piezoelectric elements. The measured electrical signal(s) carried by the measurement lead(s) 92 are applied to spool position indication system 90. The measurement system 90 takes a difference between the applied electrical signal(s) on electrical leads 46 and the measured electrical signal(s) on measurement lead(s) 92, which difference is proportional to the strain in the piezoelectric ceramic. This strain is proportional to displacement of the piezoelectric elements, and thus can be used to provide an indication of the position of the valve spool 32. To this end, measurement system 90 includes an output indicator 94 which can be observed or consulted for an indication of the position of valve spool 32 (or, alternatively, the displacement of the piezoelectric actuators). The output indicator 94 can take the form of a readout or screen or other well-known output device.

While measurement system 90 has been described above with reference to the generic embodiment of FIG. 1A, it will be appreciated that such feature may be incorporated into any other of the embodiments herein illustrated or contemplated. Moreover, measurement system 90 can be included in valve drive circuit 42 or vise-versa, and realized in/by the same hardware and/or processors.

Construction and operation of the piezoelectric activation circuits described herein can occur in myriad ways, as understood by the person skilled in the art. Drive electronics for piezoelectric elements are known, such as those described in U.S. patent application Ser. No. 10/816,000 (attorney docket 4209-26), filed Apr. 2, 2004 by Vogeley et al., entitled “Piezoelectric Devices and Methods and Circuits for Driving Same”, which is incorporated herein by reference in its entirety, or by documents referenced and/or incorporated by reference therein.

Embodiments of valves as illustrated and/or described herein or otherwise encompassed hereby solve inherent problems with current servovalve technology.

The embodiments disclosed herein or otherwise encompassed hereby also provide various advantages. For example, using the signal generated by the piezoelectric element (e.g., the measured signal applied on measurement lead(s) 92), or the current draw, as a means of measuring the spool displacement, eliminates the need to provide a secondary means for sensing the spool displacement. This simplifies servovalve design considerably and lowers cost.

As another example, by electrically connecting an piezoelectric actuator on one side of the valve spool out of phase (or poling them oppositely) with the piezoelectric actuator on the other side, the valve spool can be very quickly and accurately displaced. This arrangement provide for significantly higher operating frequencies for the servovalve. Configuring the piezoelectric actuator/valve spool assembly within the valve chamber with a slight amount of interference would allow the spring-like nature of the piezoelectric elements to keep the valve spool centered until movement is commanded.

Adjusting the fixed ends of piezoelectric actuator(s) axially (e.g., in or out) allow the spool to be centered. Overshoot of the spool can be minimized due by the valve spool being actively driven on both sides.

The piezoelectric servovalve could be used in any application that uses current technology servovalves. In addition, it could be used in applications that would be ideally suited to being driven by a servovalve, but in the past could not be due to frequency response limitations of current servovalve technology. The same concept could also be used in other valve applications such as proportional valves.

Although various embodiments have been shown and described in detail, the claims are not limited to any particular embodiment or example. None of the above description should be read as implying that any particular element, step, range, or function is essential such that it must be included in the claims scope. The scope of patented subject matter is defined only by the claims. The extent of legal protection is defined by the words recited in the allowed claims and their equivalents. It is to be understood that the invention is not to be limited to the disclosed embodiment, but on the contrary, is intended to cover various modifications and equivalent arrangements.

What is claimed is:

1. A valve comprising:
a valve body for defining a valve chamber, the valve body having plural ports;
a flow restrictor situated in the valve chamber for providing selective communication of fluid between selected ones of the plural ports;
a piezoelectric actuator situated in the valve chamber for displacing the flow restrictor to achieve the communication of the fluid between selected ones of the plural ports.

2. The valve of claim 1, further comprising a measurement system which uses a signal applied to the piezoelectric actuator and a measured signal obtained from the piezoelectric actuator to determine an indication of position of the flow restrictor.

3. The valve of claim 1, wherein the piezoelectric actuator comprises a stack of plural piezoelectric elements.

4. The valve of claim 1, wherein the piezoelectric actuator is a first piezoelectric actuator, and further comprising a second piezoelectric actuator situated in the valve chamber also for displacing the flow restrictor to achieve the communication of the fluid between selected ones of the plural ports, and wherein the first piezoelectric actuator is electrically connected out of phase or poled oppositely to the second piezoelectric actuator.

5. The valve of claim 1, wherein the piezoelectric actuator comprises two piezoelectric elements which are oriented to form a piezoelectric bellows section.

6. The valve of claim 1, wherein the piezoelectric actuator comprises plural piezoelectric bellows sections, each piezoelectric bellows section comprising two piezoelectric elements which are at least partially joined or at least partially contacting.

7. The valve of claim 1, wherein the valve body has two opposing end walls and at least one sidewall extending between the opposing end walls, the valve body defining the valve chamber between the opposing end walls and within the sidewall, the valve chamber having a major axis extending between the opposing end walls, the valve body having the plural ports provided on the sidewall, and
wherein the flow restrictor is valve spool arranged for linear displacement along the major axis and for controlling communication of the fluid between selected ones of the plural ports in accordance with the displacement.

8. The valve of claim 7, wherein the valve chamber has an adjustable effective volume.

9. The valve of claim 7, further comprising a biasing element situated in the valve chamber between a second one of the end walls of the valve body and a second end of the valve spool.

10. The valve of claim 7, further comprising a second piezoelectric actuator situated in the valve chamber between a second one of the end walls of the valve body and a second end of the valve spool.

11. The valve of claim 10, wherein the first piezoelectric actuator is electrically connected out of phase or poled oppositely to the second piezoelectric actuator.

12. The valve of claim 10, wherein an arrangement of the first piezoelectric actuator, the valve spool, and the piezoelectric actuator is slightly compressed in the valve chamber so that a spring-like nature of the piezoelectric actuators provides a force to keep the valve spool in a neutral position.

13. The valve of claim 7, wherein the piezoelectric actuator comprises a stack of plural piezoelectric elements.

14. The valve of claim 7, wherein the piezoelectric actuator comprises two piezoelectric elements which are oriented to form a piezoelectric bellows section.

15. The valve of claim 1, wherein the piezoelectric actuator is situated in the valve chamber.

16. The valve of claim 1, wherein the valve is a proportional valve.

17. A valve comprising:
a valve body for defining a valve chamber, the valve body having plural ports;
a flow restrictor situated in the valve chamber for providing selective communication of fluid between selected ones of the plural ports;
a first piezoelectric actuator and a second piezoelectric actuator for displacing the flow restrictor to achieve the communication of the fluid between selected ones of the plural ports.

18. The valve of claim 17, wherein the valve chamber has an adjustable effective volume.

19. The valve of claim 17, wherein the first piezoelectric actuator is electrically connected out of phase or poled oppositely to the second piezoelectric actuator.

20. The valve of claim 17, further comprising a measurement system which uses a signal applied to the piezoelectric actuator and a measured signal obtained from the piezoelectric actuator to determine an indication of position of the flow restrictor.

21. The valve of claim 17, wherein both the first piezoelectric actuator and the second piezoelectric actuator comprise two piezoelectric elements oriented to form a piezoelectric bellows section.

22. The valve of claim 17, wherein both the first piezoelectric actuator and the second piezoelectric actuator comprise plural piezoelectric bellows sections, each piezoelectric bellows section comprising two piezoelectric elements at least partially joined or at least partially contacting.

23. The valve of claim 20, wherein the first piezoelectric actuator and the second piezoelectric actuator has a same number of piezoelectric bellows sections.

24. The valve of claim 17, wherein the valve body has two opposing end walls and at least one sidewall extending between the opposing end walls, the valve body defining the valve chamber between the opposing end walls and within the sidewall, the valve chamber having a major axis extending between the opposing end walls, the valve body having the plural ports provided on the sidewall,
wherein the flow restrictor is valve spool arranged for linear displacement along the major axis and for controlling communication of the fluid between selected ones of the plural ports in accordance with the displacement;
wherein the first piezoelectric actuator is situated in the valve chamber between a first of the end walls of the valve body and a first end of the valve spool; and
wherein the second piezoelectric actuator is situated in the valve chamber between a second of the end walls of the valve body and a second end of the valve spool.

25. The valve of claim 22, wherein an arrangement of the first piezoelectric actuator, the valve spool, and the piezoelectric actuator is slightly compressed in the valve chamber so that a spring-like nature of the piezoelectric actuators provides a force to keep the valve spool in a neutral position.

26. The valve of claim 22, wherein the first piezoelectric actuator comprises a first stack of plural piezoelectric elements and the second piezoelectric actuator comprises a second stack of plural piezoelectric elements.

27. The valve of claim 26, wherein the first stack of plural piezoelectric elements and the second stack of plural piezoelectric elements has a same number of piezoelectric elements.

28. The valve of claim 17, wherein the first piezoelectric actuator and the second piezoelectric actuator are situated in the valve chamber.
